(19) United States
(12) Patent Application Publication
(10) Pub. No.: US 2008/0216698 A1
(43) Pub. Date: Sep. 11, 2008

(54) MICRODOT PRINTING HEAD

(75) Inventors: Amir Sadri, Toronto (CA); Nenad Kircanski, Toronto (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BIO-RAD Laboratories, Inc., Hercules, CA (US)

(21) Appl. No.: 11/682,743

(22) Filed: Mar. 6, 2007

(51) Int. Cl. B41M 3/00; B01J 19/00

(52) U.S. Cl. 101/494; 435/283.1

(57) ABSTRACT

A microdot printing head containing hollow pins as reservoirs for biological samples is manufactured with a high degree of accuracy in the spacing of the hollow pins by press fitting the pins into bushings at precisely dimensioned end sections in the bores of the bushings, and receiving the bushings into a common support block.

### BACKGROUND OF THE INVENTION

1. Field of the Invention

This invention lies in the field of simultaneous analyses of large numbers of very small biological samples. This invention specifically addresses microdot arrays as used in the biotechnology industry and the apparatus used to print such arrays on a substrate.

2. Description of the Prior Art

Microdot arrays, also called “microarrays,” of biochemical samples are commonly used in the biotechnology industry as a format for performing simultaneous analyses on multiple samples. Microdot arrays are of particular value in DNA studies and combinatorial chemistry. Microdot arrays are two-dimensional arrays of small dots of biochemical samples on surfaces such as microscope slides, the dots being precisely in uniform size and shape, and positioned at precise locations so that each dot in the array can be analyzed by automated analytical equipment. The apparatus for depositing the dots to form the array must therefore provide this level of precision and uniformity, in addition to allowing for thorough cleaning between uses.

Among the various microdot array printers of the prior art are those disclosed by Martinsky, R.S. (TeleChem International Inc.), U.S. Pat. No. 6,101,946 (issued Aug. 15, 2000), Rose, D., et al., and U.S. Pat. No. 6,551,557 B1 (issued Aug. 22, 2003). In each of these patents, the samples to be printed are loaded into pins mounted on a printing head, each pin having a reservoir at its tip for the sample, the tips being precisely aligned to achieve uniform deposition by contact of the printing head with the surface on which the array is to be formed. The pins are mounted to the printing head by the insertion of individual pins into apertures in the printing head, a procedure that is closely controlled to achieve the desired registration of the pin tips in a common plane. This attempt at precision placement of the pins in the printing head is prone to error, however, and any deviations among the positions of the pin tips can result in poorly formed microdots or an inaccurate spacing of individual microdots in the array. The present invention seeks to provide a printing head in which the pins are more easily aligned and therefore less prone to error or a lack of uniformity in size, spacing, or both.

### SUMMARY OF THE INVENTION

The present invention resides in the use of hollow pins mounted in bushings that are specially engineered to promote alignment of the pins in the printing head. The bushings in this invention contain surfaces of high tolerance that provide both a high level of control over the position of each pin in its bushing and the positions of the bushings in the printing head. The bushings themselves are therefore responsible for the precise positioning rather than the pins. The precision features of each bushing include a bore in the bushing formed such that an end section of each bore is precisely dimensioned to receive the pin, with a difference in diameter between the pin and the end section of 3 to 5 microns and tolerance of within 2.5 microns, to allow a press fit over the pin. This closely dimensioned end section of the bore is combined with a closely engineered flat (i.e., planar) section on the exterior of the bushing. The spacing between the flat section and the axis of the end section of the bore is controlled with a tolerance of within 2.5 microns such that alignment of the pins is achieved by abutment of all of the flat sections with a single bar, which is either part of a support block for the bushings in the printing head or a separate component joined to the printing head once the bushings have been inserted. The contact between the flat surfaces and the bar also prevents rotation of the bushing and hence of the pin during use, which further promotes the accuracy of the microdot deposition.

The pins for which this invention is designed are those that are highly uniform in diameter, preferably with a nominal outer diameter from which variations are within the limits of +0/−10 microns, and most preferably +0/−8 microns. The notation “+0/−10 microns” denotes that the range of variation is 10 microns and that the nominal diameter is the upper end of the range; likewise for the notation “+0/−8 microns.” Although this invention is not restricted to particular types or configurations of pins other than the requirement that they be of dimensions that are uniform to a close tolerance, the invention allows the use of capillary wire bonding tools as the pins. These are ceramic pins with a very narrow hole having a diameter ranging from 25 to 178 microns, at the tip of the tool, the hole leading to an expanded hollow interior. The hole allows a liquid sample to be drawn into the interior by capillary action and deposits the sample as a dot whose diameter is equal or close to that of the hole.

These and other objects, characteristics, and advantages will be evident from the description that follows.

### BRIEF DESCRIPTION OF THE DRAWINGS

FIG. 1 is a longitudinal cross section of a pin and bushing combination in accordance with the present invention.

FIG. 2 is an end view of the pin and bushing combination of FIG. 1.

FIG. 3 is a longitudinal cross section in perspective of the busing of FIG. 1.

FIG. 4 depicts the pin and bushing combination of FIG. 1 inserted in a holder, with the holder shown in cross section.

FIG. 5 is a perspective view of the pin and bushing combination of FIG. 1 inserted in a holder.

### DETAILED DESCRIPTION OF THE INVENTION AND PREFERRED EMBODIMENTS

The term “a” or “an” is intended to mean “one or more.” The term “comprise” and variations thereof such as “comprises” and “comprising,” when preceding the recitation of a step or an element, are intended to mean that the addition of further steps or elements is optional and not excluded. All patents, patent applications, and other published reference materials cited in this specification are hereby incorporated herein by reference in their entirety. Any discrepancy between any reference material cited herein and an explicit teaching of this specification is intended to be resolved in favor of the teaching in this specification. This includes any discrepancy between an art-understood definition of a word or phrase and a definition explicitly provided in this specification of the same word or phrase.

While the features defining this invention are capable of implementation in a variety of constructions, the invention as a whole will be best understood by a detailed examination of a specific embodiment. One such embodiment is shown in the drawings.

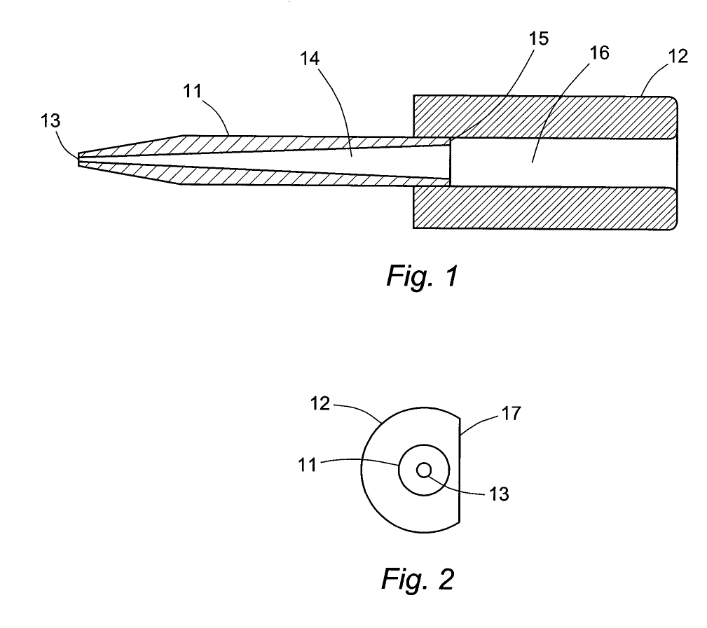

FIG. 1 is a longitudinal cross section of a single pin 11 and a single bushing 12. The exposed end of the pin is defined herein as the delivery end 13 since the pin will deliver sample from that end when the pin contacts the surface on which the microdot array is to be deposited. The pin 11 tapers toward the delivery end 13 and the delivery end itself is flat. In other embodiments, the delivery end may have a sharp edge, or it may be a flat surface with curved inner or outer edges, or it may form a continuously curved contour. The pin 11 has a through-passage 14 that extends the length of the pin and is open at both the delivery end 13 and the opposite or inner end 15. The through-passage 14 itself tapers toward the delivery end 13. The bushing 12 likewise has a through-passage, defined herein as a bore 16, which extends the length of the bushing and is open at both ends.

FIG. 2 is an end view of the pin 11 and bushing 12 taken from the delivery end 13 of the pin. FIG. 2 shows that the pin 11 is of circular cross section, and the bushing 12 is likewise of circular cross section except for a flat surface 17 on one side of the bushing.

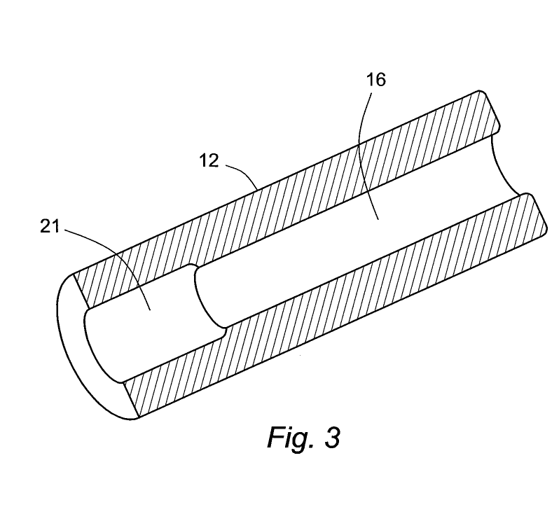

FIG. 3 is a cross section of the bushing 12 shown in perspective prior to insertion of the pin. The bore 16 terminates in an end section 21 that is precisely machined to allow the pin to be secured in the end section by forcing the inner end 15 of the pin (FIG. 1) into the end section and thereby achieving a press fit. This is preferably achieved by using a pin with an outer diameter that is slightly larger than the inner diameter of the end section, the diameter difference being about 3-5 microns and a tolerance of within about 2.5 microns. The depth of the end section 21 is not critical and can vary, provided that it receives a sufficient length of the end of the pin 11 to allow press fitting of the bushing over the pin. In preferred embodiments of the invention, the end section 21 is about 1.8 mm to about 2.2 mm in length, and the bore as a whole (including the end section 21) exceeds the end section in length by about 2.0 mm to about 20.0 mm. The pin 11 is inserted to a precise depth relative to the bore and the remainder of the bushing, and differences between pins as well as between bushings can be compensated for by adjusting the depth to which the pin is inserted. Once the pin is inserted, the bushing 12 is press fit over the end of the pin to secure the pin in place. The remainder of the bore 16 beyond the end section 21 is not as closely dimensioned as the end section and can be manufactured without precision manufacturing procedures.

In the embodiment shown in FIG. 3, the closely dimensioned end section 21 is of smaller diameter than the remainder of the bore 16. In alternative embodiments, the end section 21 can be of larger diameter than the remainder of the bore 16, or even approximately equal in diameter. In each of these alternatives, the end section 21 is preferably coaxial with the bore and with the circular section of the bushing profile. In further alternatives, the end section 21 may have a cross section that is other than circular while still being capable of a press fit around a pin 11 of circular cross section. In these further alternatives, the cross section of the end section can have three or more prongs or contact strips to contact the outer wall of the pin and to define the position of the pin relative to the bore, the spacings of the prongs or strips being closely dimensioned in the same manner as the diameter of the end section 21 in the circular cross section design depicted in the Figures. Other variations that produce equivalent results will be readily apparent to those skilled in the art.

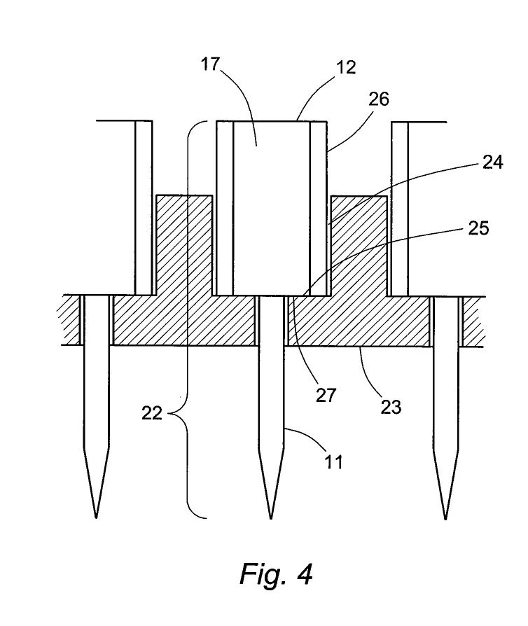

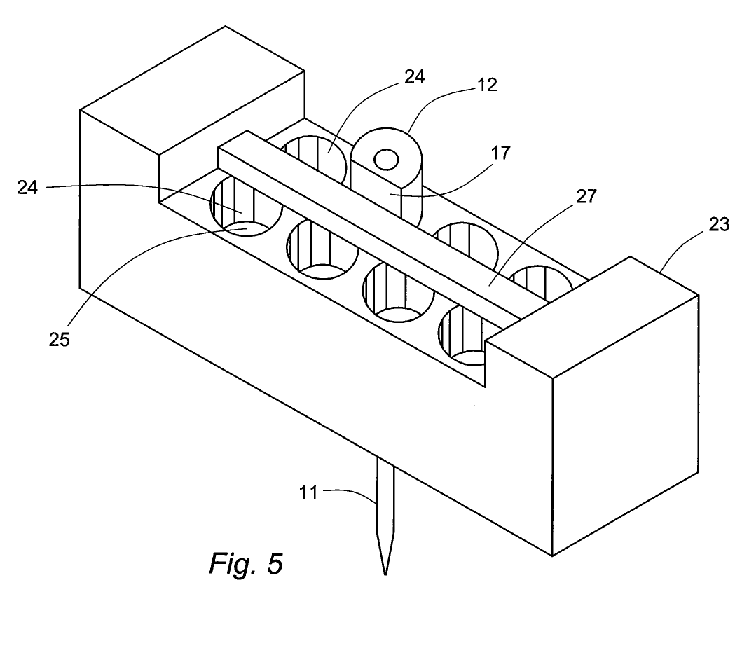

FIG. 4 shows pin 11 and bushing 12 combinations 22 inserted in a holder 23, which is also referred to herein as a block. The holder 23 is shown in cross section and the bushings 12 are oriented such that their flat surfaces 17 face forward. The pin-bushing combinations 22 pass through apertures 24 in the holder and the bushings 12 rest on shoulders 25 within the apertures. The apertures 24 are closely engineered to receive the pins and bushings in a non-friction fit that allows vertical sliding motion of the pins and bushings and yet minimizes any lateral deviations of the bushings 12 from the linear alignment. This also minimizes lateral deviations of the pins 11. In preferred embodiments, this minimization is achieved by forming the apertures so that the gap between the aperture wall and the outer surface of each bushing is within the range of 5 to 10 microns. Close engineering is also present in the contours of the exterior surfaces of the bushing. The cylindrical sides 26 of the bushing are formed to be perpendicular to the end surface 27 of the bushing, i.e., the surface at the end to which the pin 11 is inserted and that will rest on the shoulders 25 in the holder, to within 10 microns. This, combined with the flatness of the shoulders 25, helps to assure that each bushing is properly seated in the holder.

The perspective view of FIG. 5 shows apertures 24 in the holder 23 for eight pins and bushings arranged in two straight rows of four each, and shows one pin 11 and bushing 12 combination. In the embodiment shown, all pins and bushings will be oriented so that the flat surfaces 17 all face the centerline of the holder. A bar 27 is placed along the top of the holder above the centerline, to contact the flat surfaces of all of the bushings, and thereby prevent rotation of the bushings and pins during use.

As noted above, preferred pins are those designed for use as wire bonding tools. These pins are of ceramic materials, examples of which are alumina in its various forms such as sapphire and ruby; other examples are alumina/zirconia combinations and various nitrides and carbides such as nitrides and carbides of titanium, zirconium, hafnium, vanadium, niobium, tantalum, and tungsten. The sizes of the pins can vary and are not critical to the present invention. In a presently preferred embodiment, the pins are 1/16 inch (0.0625 inch, 0.159 cm) in diameter. The bushings are preferably made of stainless steel, although any metal or metal alloy can be used that can be press fit around the pin. Press fitting can be accomplished by conventional methods, and is preferably performed on a lathe. The holder 23 can be made of any material that is conveniently shaped, such as by CNC (computer numerical control) machining. One example of such a material is ULTEM® (General Electric Company), an amorphous thermoplastic polyetherimide.

Before the first use and between successive uses, the pins while mounted in the bushings can be cleaned by flushing the through-passage 14 and bore 16. This can be done by drawing a vacuum through the through-passage and bore, preferably in the direction from the bore to the through-passage and out the delivery end 13 of the pin. Conventional cleaning liquids can be used, and the cleaning operation can be enhanced by ultrasound. An example of an effective cleaning solution that can be used with ultrasound is one prepared by diluting Branson GP concentrate in distilled water. Branson GP concentrate (Branson Ultrasonics Corporation, Danbury, Conn., USA) is a blend of liquid non-ionic surfactants and detergents. In one tested method, sonication is performed for one minute, and the pins and bushings are then dried with an air stream through the through-passage and bore.

The apparatus is used for depositing microdots in an array by first using capillary action to charge the pin cavities with the samples, then lowering the holder in a vertical movement down toward the surface (such as a glass slide) on which the array is to be deposited. Once the delivery ends of the pins contact the surface, the downward motion of the holder is continued for about a hundred microns to assure full contact. The holder is then lifted to complete the deposition and disengage the pins.

While the foregoing description describes various alternatives to the components shown in the Figures, still further alternatives will be apparent to those who are skilled in the art and are within the scope of the invention.

What is claimed is:

1. Apparatus for printing microarrays, said apparatus comprising:
a plurality of hollow printing pins, each said pin having an axial aperture, all of said pins having a nominal outer diameter that is equal among said pins to within +0/10 microns;
a bushing for each said pin, each said bushing having a bore with an end section open to one end of said bushing, said end section having a longitudinal axis, each said end section being precisely dimensioned to an inner diameter 3-5 microns smaller than said nominal outer diameter of said pins and a tolerance of within 2.5 microns, to receive one of said pins and to retain said pin by a press fit;
said bushing having an outer surface with a planar section parallel to said bore, said planar section spaced from said longitudinal axis by a known distance to a tolerance of within 2.5 microns;
a block with block apertures to receive said pins and bushings in non-frictional contact; and
a bar to abut said planar sections when said pins and bushings are so received, and to thereby maintain alignment of said pin apertures with each other and prevent rotation of said pins.

2. The apparatus of claim 1 wherein said end section of said bushing terminates in an end surface that is perpendicular to said outer surface of said bushing to within ten microns.

3. The apparatus of claim 1 wherein said axial aperture of each said pin extends the length of said pin.

4. The apparatus of claim 1 wherein said axial aperture extends the length of said pin and said bore extends the length of said bushing.

5. The apparatus of claim 1 wherein said block apertures have internal shoulders to support said bushings.

6. The apparatus of claim 1 wherein said end section of said bore is from about 1.8 mm to about 2.2 mm in length, and said bore is greater in length than said end section by about 2.0 mm to about 20.0 mm.

7. The apparatus of claim 1 wherein said pins are formed from a ceramic material, and said bushings are formed of stainless steel.

8. The apparatus of claim 1 wherein said pins are wire bonding pins, and said bushings are formed of stainless steel.

9. A method for printing microarrays of biological samples, said method comprising depositing said biological samples on a substrate using the apparatus of claim 1.
